(19) United States
(12) Patent Application Publication
(10) Pub. No.: US 2023/0202746 A1
(43) Pub. Date: Jun. 29, 2023

(54) BIODEGRADABLE CAPSULES

(71) Applicant: MY TEA CUP AG, Horgen (CH)

(72) Inventors: Max SANDHERR, Männedorf (CH); Jacques SCHAEFFER, Le Mont-Pèlerin (CH)

(73) Assignee: MY TEA CUP AG, Horgen (CH)

(21) Appl. No.: 17/927,932

(22) PCT Filed: May 28, 2021
(86) PCT No.: PCT/EP2021/064419

§ 371 Date: Nov. 28, 2022

(30) Foreign Application Priority Data
May 29, 2020 (FR) FR2005734

(51) Int. Cl. B65D 85/804; C08L 67/04; C08K 3/34; B29C 45/00; B29C 45/14; B29C 45/16

(52) U.S. Cl. CPC B65D 85/804; C08L 67/04; C08K 3/34; B29C 45/0001; B29C 45/14811; B29C 45/1643; B65B 7/2842

(57) ABSTRACT

The present invention relates to the field of single-use closed capsules biodegradable by industrial composting and by domestic composting, containing at least one substance in powder form for the preparation of a drink, e.g. coffee, intended for being extracted under pressure, said capsule including a container with a bottom and a side wall having a circular rim, and a seal welded on the circumference of the rim of the container, characterized in that the bottom, the side wall and the circular rim are formed by injection molding of at least one formulation comprising:
(i) at least one polymer chosen from polyhydroxybutyrates, and
(ii) at least one ingredient chosen from silicates, vitamin E, plasticized proteins of animal or plant origin, or mixtures thereof.

### TECHNICAL FIELD OF THE INVENTION

The present invention relates to the field of single-use closed capsules which are biodegradable and compostable by industrial composting and/or by domestic composting, containing at least one substance in powder form for the preparation of a drink, e.g. coffee, intended for being extracted under pressure.

### PRIOR ART

Pre-dosed and pre-packaged portions of coffee are widely used for preparing espresso-type coffees and same are simple and easy to use.

There are generally two types of capsules on the market, rigid capsules typically consisting of a container and a seal and flexible capsules containing filter layers. The present invention relates to the first category of capsule.

Rigid capsules such as the Nespresso® capsules are widely used in Europe. Such capsules comprise a body or a container and a seal which are traditionally made essentially of aluminum.

There are also capsules the seal and the body of which are made of plastic materials.

The capsules currently existing on the market do not meet the three requirements of: (i) being biodegradable by industrial composting, (ii) being biodegradable by domestic composting and (iii) having a barrier function with regard to oxygen and water vapor.

A subject matter of the present invention is thus to provide capsules which are compostable, by industrial composting and/or by domestic composting, while having a good barrier function with regard to oxygen and water vapor, and which can be used for preparing a drink, such as a satisfactory quality coffee, when used in an espresso machine, more particularly in a Nespresso® machine.

### SUMMARY OF THE INVENTION

More precisely, the present invention relates to a closed capsule 1, intended for being extracted under pressure, containing a substance in the form of a powder for the preparation of a drink, said capsule comprising an container 2 with a bottom 3 and a side wall 4 having a circular rim 5, and a seal (6) welded to the periphery of the circumference of the container rim, characterized in that the bottom, the side wall and the circular rim are formed by injection molding of at least one formulation comprising:

(i) at least one polymer chosen from polyhydroxybutyrates, and

(ii) at least one ingredient chosen from silicates, vitamin E, plasticized proteins of animal or plant origin, or mixtures thereof.

According to one embodiment of the invention, the formulation comprises from 50 to 99.9% by weight, preferentially from 75 to 99.5% by weight, advantageously from 90 to 99% by weight, of polymer(s) chosen from polyhydroxybutyrates, such as polyhydroxybutyrate/hydroxyvalerate, and mixtures thereof, with respect to the total weight of the formulation.

According to one embodiment of the invention, the formulation comprises from 0.1 to 50% by weight, preferentially from 0.5 to 25% by weight, advantageously from 1 to 10% by weight, of ingredient(s) chosen from silicates, vitamin E, plasticized proteins of either plant or animal origin, or mixtures thereof, with respect to the total weight of the formulation.

According to one embodiment of the invention, the formulation further comprises (iii) at least one polyvinyl alcohol, preferentially in a quantity ranging from 1 to 30% by weight, preferentially from 2 to 20% by weight, advantageously from 5 to 10% by weight, with respect to the total weight of the formulation.

According to another embodiment, the formulation comprises less than 1% by weight of PVOH, preferentially less than 0.5% by weight of PVOH, with respect to the total weight of the formulation. More specifically, according to one embodiment of the invention, the formulation is free of any PVOH.

Preferentially, the BET specific surface area of the silicates ranges from 1 to 250 m²/g and/or the median diameter of the silicates ranges from 0.5 to 20 μm and/or the dimensional shape factor of the silicates is greater than or equal to 1:2.

Preferentially, the silicates are chosen from aluminum silicates, aluminum and magnesium silicates, preferentially from aluminum silicates.

According to one embodiment of the invention, the formulation further comprises one or a plurality of additives chosen from mineral fillers different from silicates, peroxide products, vitamins different from vitamin E, waxes of either animal or plant origin.

Preferentially, said additive or additives represent from 0.05 to 20% by weight, preferentially from 0.1 to 15% by weight, more preferentially from 1 to 10% by weight, of the total weight of the formulation.

According to one embodiment of the invention, the capsule is as per the EN 13432 standard.

According to one embodiment of the invention, the capsule contains at least 60% by weight of material of biosourced origin.

According to one embodiment of the invention, the bottom, the side wall and the circular rim are formed by injection molding in a single layer of said formulation in a mold.

According to one embodiment of the invention, the seal consists of a monolayer or multilayer film made of one or a plurality of materials chosen from biodegradable materials, preferentially chosen from paper, nonwoven fabrics, cellulose, SiOx layers, polylactic acid polymers, polyhydroxyalkanoates, hybrid layers of organic polymer and inorganic fibers, layers coated with polyvinyl alcohol or ethylene-vinyl alcohol copolymer, layers metallized e.g. with aluminum, where such layers of materials can be separated by a layer of adhesive.

Preferentially, the seal consists of a multilayer consisting of:

i) a film of paper or filter paper,

ii) a barrier layer, and

iii) a nonwoven fabric layer, said nonwoven fabric layer being inside the capsule.

More preferentially, the barrier layer consists of one or a plurality of layers chosen from:
a hybrid barrier layer of organic polymer and inorganic compounds, and/or
a SiOx barrier check layer, and/or
a cellulose barrier layer.

The invention further relates to the manufacturing method according to the invention, comprising the steps of:

a) preparing a formulation by mixing the ingredients,

b) injection molding of the formulation obtained in step a) in a mold so as to form a layer of the container, one or a plurality, if appropriate, of layers of the container can be injection molded using a formulation different from the formulation in step a),

c) filling the container with the substance in powder form,

d) closing the container with the seal so as to form the capsule.

The capsules according to the invention meet the compostability standard EN 13432, being then called biodegradable in industrial composting conditions.

There are currently no international or European standards but only national standards for home composting. The capsules according to the invention are biodegradable in domestic composting conditions according to French recommendations. In particular, the capsules are as per the NF T 51800 standard (2015). The capsules according to the invention will typically meet the Australian standard AS 5810 (2010).

The capsules according to the invention typically comprise at least 60% by weight of materials of biosourced origin.

The capsules according to the invention are stable in storage since they have a good sealing against oxygen and water vapor. In particular, the capsules can be stored and kept for at least 12 months before being consumed.

The capsules according to the invention are compatible with Nespresso® machines.

The capsules according to the invention have a barrier function, i.e. same will typically have a permeability to oxygen of less than 3.0×10⁻³ cm³/capsule/24 hrs at 0.21 atm at 23° C. and 50% RH (relative humidity), preferentially less than or equal to 2.5×10⁻³ cm³/capsule/24 hrs at 0.21 atm at 23° C. and 50% RH, further preferentially less than or equal to 1.5×10⁻³ cm³/capsule/24 hrs at 0.21 atm at 23° C. and 50% RH, measured as per the ASTM F1307 standard or as per the ISO 15105-2 standard.

Furthermore, the capsules according to the invention are compostable by industrial composting and/or by domestic composting, advantageously they are compostable both by industrial composting and by domestic composting.

Other features, variants and advantages of the implementation of the invention will become clearer upon reading the following description and the examples, given as an illustration of the invention, but not limited to.

### BRIEF DESCRIPTION OF FIGURES

FIG. 1 is a schematic cross-sectional view of a container implemented according to the invention.

FIG. 2 is a schematic cross-sectional view of a capsule implemented according to the invention.

### DETAILED DESCRIPTION OF THE INVENTION

The present invention relates to a sealed capsule in the form of an individual part, suitable for being extracted under pressure, containing at least one edible substance in powder form, for the preparation of a drink such as ground coffee, tea or soluble powders.

The capsule is suitable for being opened under the effect of the rise in pressure when an extraction liquid is injected.

Preferentially, the capsule according to the invention consists of at least 95% by weight of biodegradable materials, preferentially 100% of biodegradable materials.

“Biodegradable” refers to a material apt to decompose under the action of living organisms, such as bacteria, fungi or algae, in order to be converted e.g. into carbon dioxide, water and/or methane.

The capsule according to the invention includes a container and a seal welded onto the circumference of the rim of the container. The container thus comprises a bottom and a side wall with a circular rim. The circular rim holds the capsule when it is inserted into a machine and creates a sealing zone when used in said machine, such as a coffee machine.

The capsule container is typically prepared by one-piece molding of the bottom, of the side wall and of the circular rim, starting from a formulation. The one-piece molding can be carried out in one or a plurality of layers, with the proviso that at least one layer consists of the formulation described in the invention. When two layers are involved, typically each layer will consist of a different formulation. If the molding of the container is produced in two layers e.g., a layer of the formulation according to the invention and a barrier layer consisting e.g. of polyvinyl alcohol (PVOH) can be used.

When three layers are involved, typically, at least two different layers, at least one layer of which will consist of the formulation of the invention, can be used. One of the three layers can then be a barrier layer consisting e.g. of PVOH.

According to a preferred embodiment, the container is molded in a single layer of the formulation according to the invention.

The formulation comprises:
(i) at least one polymer chosen from polyhydroxybutyrates (PHB),
(ii) at least one ingredient chosen from silicates, vitamin E, plasticized proteins of either animal or plant origin, and mixtures thereof,
(iii) and, if appropriate, at least one polyvinyl alcohol (PVOH) polymer, with the proviso that said PVOH polymer is biodegradable as per the standard EN 13432.

Typically, all ingredients in the formulation are biodegradable.

According to one embodiment, the PHBs are chosen from poly3-hydroxybutyrate-co-3-hydroxyhexanoate polymers (PHBH), polyhydroxybutyrate/hydroxyvalerate polymers (PHBV), and a mixture thereof.

According to one embodiment, the silicates are chosen from aluminum silicates, aluminum silicates and magnesium silicates, preferentially from aluminum silicates.

Aluminum and magnesium silicates include montmorillonites.

According to one embodiment, the silicates are chosen from phyllosilicates, preferentially aluminum phyllosilicates.

According to one embodiment, the phyllosilicates are chosen from kaolinites, halloysites and mixtures thereof.

According to one embodiment, aluminum silicates are kaolins.

According to one embodiment, the silicates, preferentially aluminum silicates, have a particle size with a median diameter measured by laser size analysis ranging from 0.5 μm to 20 μm, and/or a specific surface area (BET method) ranging from 1 to 250 m²/g.

Typically, such silicates have dimensional shape factors greater than or equal to 1:2, advantageously greater than or equal to 1:4, and particularly greater than or equal to 1:6, referred to as silicates with an acicular shape. The shape factor can be determined by microscopy, e.g. by scanning electron microscopy (SEM). The acicular fillers are oriented preferentially during the injection of the capsule along the direction of flow and provide:
a mechanical reinforcement along the long direction (less crushing of the capsule), and
an increase in the tortuosity of the polymer matrix provided by the presence of particles with acicular shape providing an additional barrier effect.

According to one embodiment, the silicates, typically having an acicular shape, will have one or even two nanometric dimensions (from 1 nm to 100 nm), with the proviso that the silicates comprise at least one micrometric dimension (from 1 μm to less than 1 mm), so as to meet the standards on food contact. Such nano/micro dimensioning can be used for introducing a smaller quantity of silicates, compared to a micrometric carbonate or talc, and has at least 2 advantages:
a weight reduction of the finished part, while maintaining the same mechanical properties, which is an environmental gain as well, and
the preservation of the plastic effect of the matrix (same modulus but with a better elongation at break), which entails more plastic deformability and less breakage in use and transport.

According to one embodiment, the formulation comprises:
(i) from 50 to 99.9% by weight, preferentially from 75 to 99.5% by weight and advantageously from 90 to 99% by weight, of the composition of polymers chosen from PHBs,
(ii) from 0.1 to 50% by weight, preferentially from 0.5 to 25% by weight, more preferentially from 1 to 10% by weight, of ingredient(s) chosen from silicates, vitamin E, plasticized proteins of either animal or plant origin and mixtures thereof,

with respect to the total weight of the formulation.

According to one embodiment, the formulation comprises:
(i) from 50 to 99.9% by weight, preferentially from 75 to 99.5% by weight and advantageously from 90 to 99% by weight, of the composition of polymers chosen from PHBs,
(ii) from 0.1 to 50% by weight, preferentially from 0.5 to 25% by weight and advantageously from 1 to 10% by weight, of ingredient(s) chosen from silicates, vitamin E, and mixtures thereof

with respect to the total weight of the formulation.

According to one embodiment, the formulation comprises:
(i) from 50 to 99.9% by weight, preferentially from 75 to 99.5% by weight and advantageously from 90 to 99% by weight, of the composition of polymers chosen from polyhydroxybutyrate/hydroxyvalerate (PHBV),
(ii) from 0.1 to 50% by weight, preferentially from 0.5 to 25% by weight, advantageously from 1 to 10% by weight, of aluminum silicates,

with respect to the total weight of the formulation.

According to one embodiment, the formulation comprises:
(i) from 50 to 98.9% by weight, preferentially from 75 to 97.5% by weight and advantageously from 80 to 94% by weight, of the composition of polymers chosen from PHBs,
(ii) from 0.1 to 40% by weight, preferentially from 0.5 to 25% by weight, more preferentially from 1 to 10% by weight, of ingredient(s) chosen from silicates, aluminum, plasticized proteins of either animal or plant origin, vitamin E, or mixtures thereof,
(iii) from 1 to 30% by weight, preferentially from 2 to 20% by weight, advantageously from 5 to 10% by weight, of PVOH,

with respect to the total weight of the formulation.

According to one embodiment, the formulation comprises:
(i) from 50 to 98.9% by weight, preferentially from 75 to 97.5% by weight and advantageously from 80 to 94% by weight, of the composition of polymers chosen from PHBVs,
(ii) from 0.1 to 40% by weight, preferentially from 0.5 to 25% by weight, advantageously from 1 to 10% by weight, of aluminum silicates,
(iii) from 1 to 30% by weight, preferentially from 2 to 20% by weight, advantageously from 5 to 10% by weight, of PVOH,

with respect to the total weight of the formulation.

According to one particular embodiment of the invention, the formulation comprises:
60 to 95% by weight of a polymer mixture consisting of a poly3-hydroxybutyrate-co-3-hydroxyhexanoate polymer (PHBH) and a polyhydroxybutyrate/hydroxyvalerate polymer (PHBV),
to 40% by weight of at least one silicate,

with respect to the total weight of the formulation.

According to one particular embodiment of the invention, the formulation comprises:
70 to 90% by weight of a polymer mixture consisting of a poly3-hydroxybutyrate-co-3-hydroxyhexanoate polymer (PHBH) and a polyhydroxybutyrate/hydroxyvalerate polymer (PHBV),
10 to 30% by weight of at least one silicate,

with respect to the total weight of the formulation.

According to one particular embodiment of the invention, the formulation comprises:
60 to 80% by weight of a polyhydroxybutyrate/hydroxyvalerate polymer (PHBV),
to 20% by weight of a poly3-hydroxybutyrate-co-3-hydroxyhexanoate polymer (PHBH),
to 30% by weight of at least one kaolin,

with respect to the total weight of the formulation.

The formulation can optionally further comprise one or a plurality of additives chosen from mineral fillers different from silicates, peroxide products, vitamins different from vitamin E, waxes of either animal or plant origin. According to such embodiment, said additive or additives represent from 0.05 to 20% by weight, preferentially from 0.1 to 15% by weight, advantageously from 1 to 10% by weight, of the total weight of the formulation.

Preferentially, the formulation consists entirely of biodegradable materials.

The formulation implemented in the invention is typically produced by extrusion, preferentially by twin-screw extrusion. A formulation in the form of granules can then be obtained.

Typically, the capsule is as per the EN 13432 standard.

According to one embodiment, the capsule according to the invention contains at least 60% by weight of materials of biosourced origin, with respect to the total weight of the capsule. The concentration of biosourced materials can be determined as per the standard ISO16620-1-3.

The capsule contains a substance in powder form for the preparation of a drink. The drink will preferentially be coffee, tea, a chocolatey product, preferentially coffee. The substance in the form of a powder, for preparing coffee, can be roasted and ground coffee, soluble coffee or a mixture thereof.

The capsule according to the invention can be prepared by the following method:
a) preparing the formulation by the extrusion of the ingredients,
b) Injection molding of the formulation in a mold so as to form a layer of the container,
   if appropriate, one or a plurality of other layers of the container can be injection molded, typically using at least one formulation different from the formulation used in step a), e.g. using a PVOH formulation,
c) filling the container with the substance in powder form,
d) closing the container using the seal for forming the capsule.

Preferentially, the preparation process comprises a single injection molding step using the formulation defined in the invention. The container according to the invention will then, according to this embodiment, consist of only one layer with the formulation defined in the invention.

The container generally has a thickness ranging from 0.2 to 1 mm, preferentially from 0.5 to 0.8 mm.

The bottom of the container is apt to be perforated and can, if appropriate, comprise a recess.

The circular rim is formed during the production of the container by thermoplastic injection into a mold having the appropriate shape. Said circular rim can have a width ranging from 1 to 4 mm. The main function of the circular rim is to abut against an edge of a capsule holder of the beverage making apparatus during the phase of extracting the beverage, e.g. coffee, and thus to allow the capsule to be held firmly during the rise in pressure.

The mold for injection will thus typically comprise a bottom, a side wall and a circular rim, in order to obtain each of the layers of the container, preferentially the container will consist of a single layer of the formulation according to the invention.

The seal typically has a size calibrated so as to match the contour of the circular rim of the capsule container, thus closing the container.

The substance in powder form, preferentially ground coffee, is thus trapped inside the hollow container. Typically, the seal will be bonded or heat-welded to the circular rim of the capsule container.

According to one embodiment, the seal consists of a biodegradable film. Typically, the seal can be either a monolayer or a multilayer film with a total thickness ranging from 90 to 300 μm.

The seal can thus consist of one or a plurality of layers of materials chosen from paper, nonwoven fabrics, cellulose, barrier layers, where the layers of materials can be separated by a layer of adhesive, which would as such be biodegradable.

Nonwoven fabrics include polylactic acid (PLA) nonwoven fabrics or polyhydroxyalkanoate (PHA) nonwoven fabrics.

Barrier layers include SiOx layers, PLA layers, organic polymer and inorganic fiber hybrid layers, layers coated with PVOH (polyvinyl alcohol) or EVOH (ethylene-vinyl alcohol copolymer), layers metallized e.g. with aluminum, and barrier layers produced by vaporization (plasma or air vacuum deposition).

“Barrier” refers to the ability of a material to limit or to reduce the passage of oxygen and/or water vapor or moisture, and can then be referred to as a barrier layer to oxygen and/or moisture. Hybrid layers of organic polymer and inorganic compounds include layers comprising silicic acid polycondensates modified by organic groups and inorganic compounds. Organic groups include polycaprolactone, chitosan and celluloses. The silicic acid polycondensate contains Si—O—Si bonds. Inorganic compounds include silicon cations optionally in combination with other cations such as aluminum, titanium, boron or zirconium.

Examples of the production of the seal include:
a seal consisting of:
   i) a parchment paper film,
   ii) an adhesive layer and/or a barrier layer,
   (iii) a nonwoven fabric layer,
   once implemented in the capsule, the layer i) is the outer layer and the layer iii) is the layer inside the capsule;
a seal consisting of:
   i) a filter paper film,
   ii) a barrier layer,
   iii) a barrier film such as a cellulose film or PLA film,
   iv) a nonwoven fabric layer,
   once implemented in the capsule, the layer i) is the outer layer and the layer iv) is the layer inside the capsule;
a seal consisting of:
   i) a cellulose film, e.g. such as Naturflex®,
   ii) a nonwoven fabric layer,
   once implemented in the capsule, the layer i) is the outer layer and the layer iv) is the layer inside the capsule;
a seal consisting of:
   i) a paper or filter paper film,
   ii) a hybrid barrier layer of organic polymer and inorganic compounds,
   iii) an SiOx barrier layer,
   iv) a cellulose barrier film,
   v) a nonwoven fabric layer,
   once implemented in the capsule, the layer i) is the outer layer and the layer iv) is the layer inside the capsule.

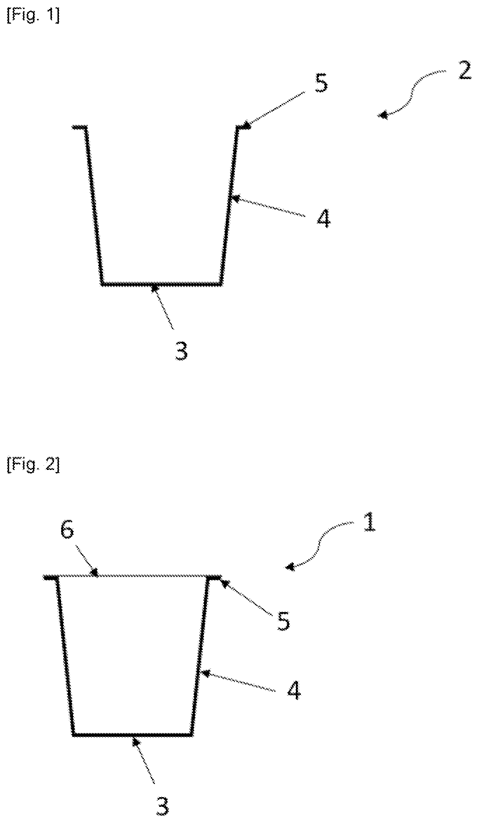

Referring to FIG. 1, the container 2 according to the invention consists of a bottom 3 with a substantially circular shape and of a side wall 4 provided with a circular rim 5.

Referring to FIG. 2, the capsule 1 according to the invention comprises the container 2 and a seal 6. The container 2 consists of a bottom 3 with a substantially circular shape and of a side wall 4 provided with a circular rim 5. The capsule according to the invention further comprises a substance in the form of a powder for the preparation of a drink (introduced before dosing the capsule with the seal) which has not been shown in FIG. 2.

The invention further relates to a manufacturing method for a capsule according to the invention. The method according to the invention comprises the steps of:
a) preparing the formulation by the extrusion of the ingredients,
b) Injection molding of the formulation in a mold so as to form a layer of the container,
   optionally one or a plurality of other layers of the container can be injection molded, typically using at least one formulation different from the formulation used in step a), e.g. using a PVOH formulation,
c) filling the container with the substance in powder form,
d) closing the container using the seal for forming the capsule.

Preferentially, the preparation process comprises a single injection molding step using the formulation defined in the invention. The container according to the invention will then, according to this embodiment, consist of only one layer with the formulation defined in the invention.

Finally, the invention relates to the use of a formulation as defined in the present invention for preparing a capsule having a low permeability to gas and moisture.

Typically, the container according to the invention has a permeability to oxygen of less than 3.0×10⁻³ cm³/capsule/24 hrs at 0.21 atm at 23° C. and 50% RH (relative humidity), preferentially less than or equal to 2.5×10⁻³ cm³/capsule/24 hrs at 0.21 atm at 23° C. and 50% RH, further preferentially less than or equal to 1.5×10⁻³ cm³/capsule/24 hrs at 0.21 atm at 23° C. and 50% RH, measured as per the ASTM F1307 standard or as per the ISO 15105-2 standard. During the permeability measurement test, the container is fastened onto a plate, so that the plate “closes” the container.

### EXAMPLES

A plurality of containers was prepared, from different formulations, so as to determine the permeability to oxygen of the containers.

Table 1 describes the formulations which have been prepared. The percentages indicated are percentages by weight with respect to the total weight of the formulation.

TABLE 1

| | 1 | 2 | 3 | 4 | 5 | 6 |
|---|---|---|---|---|---|---|
| aluminum | 100% | | | | | |
| PLA (Polylactic Acid) | | 78% | | | | |
| cellulose | | 22% | | | | |
| PBS | | | 60% | | | |
| (poly(butylene)succinate) | | | | | | |
| Sunflower seed shell fiber | | | 40% | | | |
| PHBH | | | | 98% | | |
| Polyethylene wax | | | | 2% | | |
| PHBV | | | | | 90% | 95% |
| Vitamin E | | | | | 10% | |
| talc | | | | | | 5% |

Containers were prepared, according to the above-described method, namely by extrusion in a twin-screw extruder of the ingredients for obtaining formulation granules, followed by injection molding in only one layer in a mold so as to form the bottom, the side wall and the circular rim of the container.
The permeability to oxygen of the containers was measured as per the ASTM F1307 standard or the ISO 15105-2 standard and is shown in Table 2.

TABLE 2

| | Permeability to oxygen |
|---|---|
| | (cm³/capsule/24 hrs at 0.21 |
| | atm at 23° C. and 50% RH) |
| 1 | 0.1 × 10⁻³ |
| 2 | 5.8 × 10⁻³ |
| 3 | 8.55 × 10⁻³ |
| 4 | 5.93 × 10⁻³ |
| 5 | 2.9 × 10⁻³ |
| 6 | 1.5 × 10⁻³ |

As shown in Table 2, the capsules comprising the container as defined in the invention, i.e. with the formulation of the invention, have a very low permeability to oxygen. On the contrary, the formulations of biodegradable materials (2, 3, 4) lead to containers with greater permeability to oxygen.
The examples show that the invention thus makes it possible to obtain a biodegradable capsule, in particular under industrial composting and domestic composting conditions, which also has a very low permeability to oxygen, even when the container consists of only one layer of formulation.

1-15. (canceled)

16. A closed capsule intended for being extracted under pressure, containing a substance in the form of a powder for the preparation of a drink, said capsule including a container with a bottom and a side wall having a circular rim, and a seal (6) welded to the periphery of the rim of the container, characterized in that the bottom, the side wall and the circular rim are formed by injection molding of at least one formulation comprising:
(i) at least one polymer chosen from polyhydroxybutyrates, and
(ii) at least one ingredient chosen from silicates, vitamin E, plasticized proteins of animal or plant origin, or mixtures thereof.

17. The capsule according to claim 16, wherein the formulation comprises from 50 to 99.9% by weight, preferentially from 75 to 99.5% by weight, advantageously from 90 to 99% by weight, of polymer(s) chosen from polyhydroxybutyrates, such as polyhydroxybutyrate/hydroxyvalerate, and mixtures thereof, with respect to the total weight of the formulation.

18. The capsule according to claim 16, wherein the formulation comprises from 0.1 to 50% by weight, preferentially from 0.5 to 25% by weight, advantageously from 1 to 10% by weight, of ingredient(s) chosen from silicates, vitamin E, plasticized proteins of either plant or animal origin, or mixtures thereof, with respect to the total weight of the formulation.

19. The capsule according to claim 16, wherein the formulation further comprises (iii) at least one polyvinyl alcohol, preferentially in a quantity ranging from 1 to 30% by weight, preferentially from 2 to 20% by weight, advantageously from 5 to 10% by weight, with respect to the total weight of the formulation.

20. The capsule according to claim 16, wherein the BET specific surface area of the silicates ranges from 1 to 250 m²/g and/or the median diameter of the silicates ranges from 0.5 to 20 μm and/or the dimensional shape factor of the silicates is greater than or equal to 1:2.

21. The capsule according to claim 16, wherein the silicates are chosen from aluminum silicates, aluminum and magnesium silicates, preferentially from aluminum silicates.

22. The capsule according to claim 16, wherein the formulation further comprises one or a plurality of additives chosen from mineral fillers different from silicates, peroxide products, vitamins different from vitamin E, waxes of either animal or plant origin.

23. The capsule according to claim 22, wherein said additive or additives represent from 0.05 to 20% by weight, preferentially from 0.1 to 15% by weight, advantageously from 1 to 10% by weight, of the total weight of the formulation.

24. The capsule according to claim 16, as per the standard EN 13432.

25. The capsule according to claim 16, containing at least 60% by weight of biosourced material.

26. The capsule according to claim 16, wherein the bottom, the side wall and the circular rim are formed by injection molding in a single layer of said formulation in a mold.

27. The capsule according to claim 16, wherein the seal consists of a monolayer or multilayer film made of one or a plurality of materials chosen from biodegradable materials, preferentially chosen from paper, nonwoven fabrics, cellulose, SiOx layers, polylactic acid polymers, polyhydroxyalkanoates, hybrid layers of organic polymer and inorganic fibers, layers coated with polyvinyl alcohol or ethylene-vinyl alcohol copolymer, layers metallized e.g. with aluminum, where such layers of materials can be separated by a layer of adhesive.

28. The capsule according to claim 27, wherein the seal is made of a multilayer consisting of:
i) a paper or filter paper film,
ii) a barrier layer,
iii) a nonwoven fabric layer, said nonwoven fabric layer being inside the capsule.

29. The capsule according to claim 28, wherein the barrier layer consists of one or a plurality of layers chosen from:
a hybrid barrier layer of organic polymer and inorganic compounds, and/or
an SiOx barrier layer, and/or
a cellulose barrier layer.

30. A manufacturing method for a capsule according to claim 16, comprising the steps of:
a) preparing a formulation by mixing the ingredients,
b) injection molding of the formulation obtained in step a) in a mold so as to form a layer of the container, if appropriate one or a plurality of layers of the container being injection molded using a formulation different from the formulation in step a),
c) filling the container with the substance in powder form,
d) closing the container using the seal for forming the capsule.
